(19) United States
(12) Patent Application Publication
(10) Pub. No.: US 2010/0284422 A1
(43) Pub. Date: Nov. 11, 2010

(54) NETWORK CONTROL CIRCUIT HAVING PSEUDO HOT PLUG FUNCTION AND PSEUDO HOT PLUG METHOD FOR NETWORK CONTROL CIRCUIT

(76) Inventors: Shu-Hung Wang, Hsinchu City (TW); Yi-De Ting, Hsinchu County (TW); Hsiu-Che Chao, Taipei County (TW); Chien-Chang Tseng, Tainan County (TW)

Correspondence Address: NORTH AMERICA INTELLECTUAL PROPERTY CORPORATION, P.O. BOX 506, MERRIFIELD, VA, 22116, US

(21) Appl. No.: 12/507,807

(22) Filed: Jul. 23, 2009

(30) Foreign Application Priority Data
May 7, 2009 (TW) 098115130

(51) Int. Cl. H04L 12/66

(52) U.S. Cl. 370/463

(57) ABSTRACT

The present invention provides a network control circuit having a pseudo hot plug function and a pseudo hot plug method for a network control circuit. The network control circuit comprises: a network processing module for executing a network function of the network control circuit, a network detecting unit for detecting a connection status of a network connected to the network control circuit so as to generate a detecting result, and a control unit coupled to the network detecting unit and the network processing module, for determining whether to turn off the network processing module according to the detecting result. When the detecting result shows that the connection status of the network is un-connecting, the control unit determines to turn off the network processing module. When the detecting result shows that the connection status of the network is connecting, the control unit determines to turn on the network processing module.

### BACKGROUND OF THE INVENTION

1. Field of the Invention

The present invention relates to a network control circuit, and more particularly, to a network control circuit having a pseudo hot plug function and a pseudo hot plug method for a network control circuit.

2. Description of the Prior Art

In general, the specifications of the Peripheral Component Interconnect (PCI), the Peripheral Component Interconnect Extended (PCI-X), and the Peripheral Component Interconnect Express (PCI-E) do not support pseudo hot plug function. The network control circuit in a traditional computer always consumes power no matter the connection status of the network is connecting or un-connecting, and it results in a problem of wasting power.

### SUMMARY OF THE INVENTION

It is therefore one of the objectives of the present invention to provide a network control circuit having a pseudo hot plug function and a pseudo hot plug method for a network control circuit, so as to solve the above problem.

In accordance with an embodiment of the present invention, a network control circuit is disclosed. The network control circuit comprises: a network processing module, a network detecting unit, and a control unit. The network processing module is utilized for executing a network function of the network control circuit. The network detecting unit is utilized for detecting a connection status of a network connected to the network control circuit so as to generate a detecting result. The control unit is coupled to the network detecting unit and the network processing module, and utilized for determining whether to turn off the network processing module according to the detecting result. When the detecting result shows that the connection status of the network is un-connecting, the control unit determines to turn off the network processing module. When the detecting result shows that the connection status of the network is connecting, the control unit determines to turn on the network processing module.

In accordance with an embodiment of the present invention, a pseudo hot plug method for a network control circuit is disclosed. The pseudo hot plug method comprises: detecting a connection status of a network connected to the network control circuit so as to generate a detecting result; and determining whether to turn off the network processing module according to the detecting result.

Briefly summarized, the network control circuit disclosed by the present invention has a pseudo hot plug function so as to save power efficiently. Furthermore, the pseudo hot plug method disclosed by the present invention can be applied to various network control circuits.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a simplified block diagram of a network control circuit in accordance with a first embodiment of the present invention.

FIG. 2 shows a simplified block diagram of a network control circuit in accordance with a second embodiment of the present invention.

FIG. 3 is a flowchart showing a pseudo hot plug method applied to a network control circuit in accordance with the operation schemes of the network control circuit in the above embodiments of the present invention.

### DETAILED DESCRIPTION

Certain terms are used throughout the following description and the claims to refer to particular system components. As one skilled in the art will appreciate, manufacturers may refer to a component by different names. This document does not intend to distinguish between components that differ in name but not function. In the following discussion and in the claims, the terms “include”, “including”, “comprise”, and “comprising” are used in an open-ended fashion, and thus should be interpreted to mean “including, but not limited to . . . ”. The terms “couple” and “coupled” are intended to mean either an indirect or a direct electrical connection. Thus, if a first device couples to a second device, that connection may be through a direct electrical connection, or through an indirect electrical connection via other devices and connections.

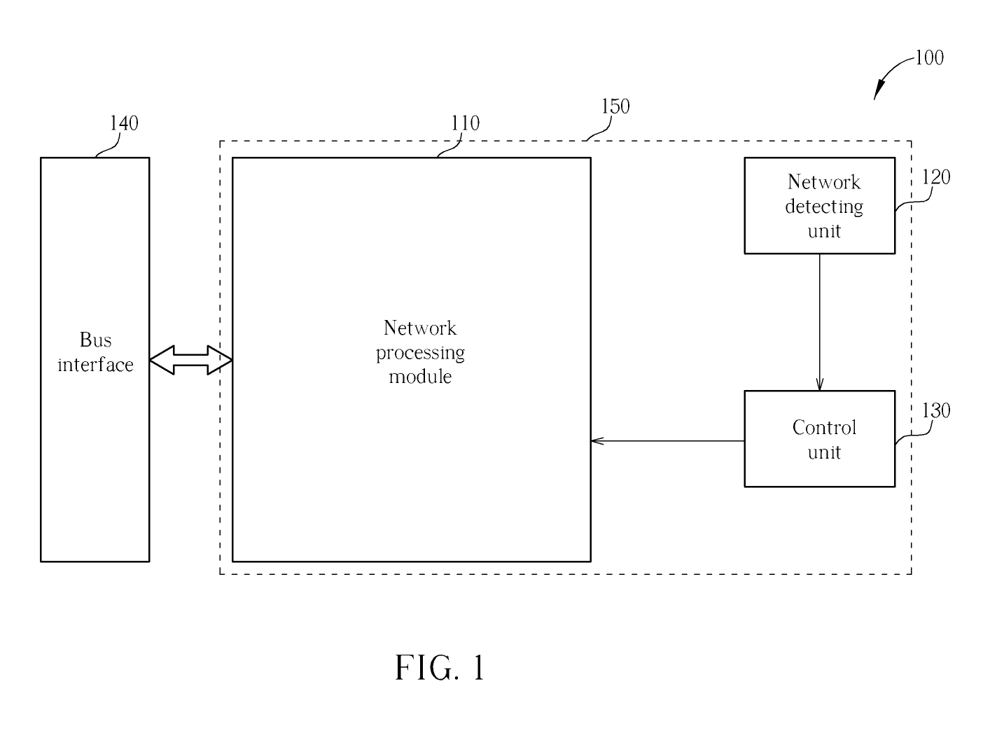

Please refer to FIG. 1. FIG. 1 shows a simplified block diagram of a network control circuit 100 in accordance with a first embodiment of the present invention. As shown in FIG. 1, the network control circuit 100 comprises: a network processing module 110, a network detecting unit 120, and a control unit 130. The network processing module 110 is coupled to the bus interface 140, and the bus interface 140 can be a Peripheral Component Interconnect (PCI), a Peripheral Component Interconnect Extended (PCI-X), a Peripheral Component Interconnect Express (PCI-E), or an Universal Serial Bus. In addition, the network processing module 110, the network detecting unit 120, and the control unit 130 are integrated in a network control chip 150 in this embodiment.

The network processing module 110 is utilized for executing a network function of the network control circuit 100. The network detecting unit 120 is utilized for detecting a connection status of a network (not shown) connected to the network control circuit 100 so as to generate a detecting result. The control unit 130 is coupled to the network detecting unit 120 and the network processing module 110, and utilized for determining whether to turn off the network processing module 110 according to the detecting result. When the detecting result shows that the connection status of the network is un-connecting, the control unit 130 determines to turn off the network processing module 110. When the detecting result shows that the connection status of the network is connecting, the control unit 130 determines to turn on the network processing module 110. For example, the control unit 130 can turn off or turn on the network processing module 110 by performing clock-gating operation, power-gating operation, or turning off or turning on phase lock loop (PLL). In this way, the network control circuit 100 can have a pseudo hot plug function so as to save power efficiently.

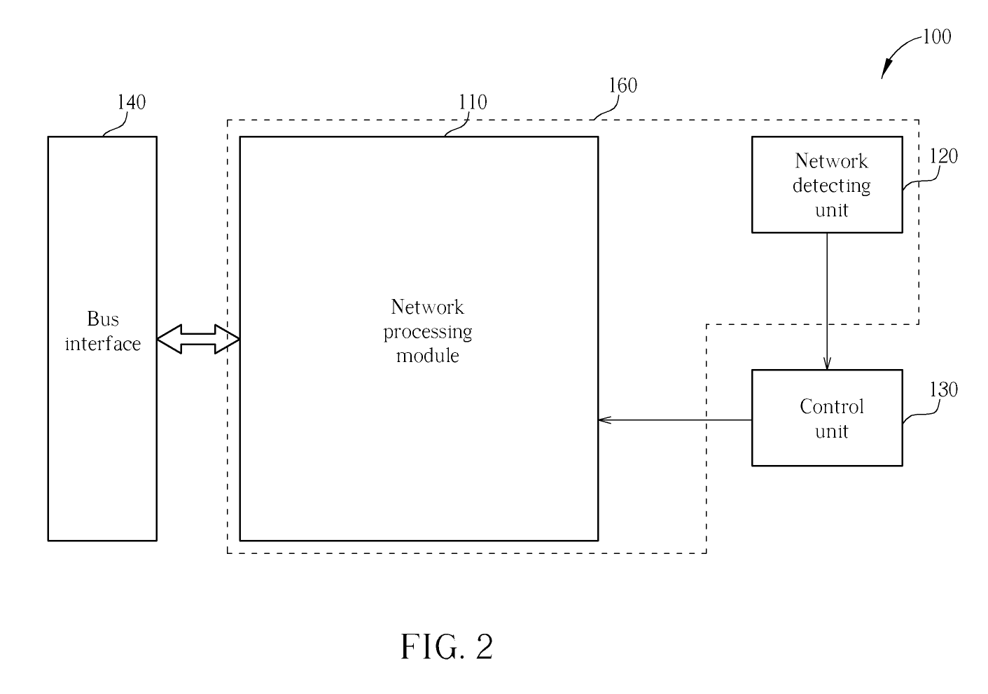

In addition, in a second embodiment of the present invention, the network processing module 110 and the network detecting unit 120, are integrated in a network control chip 160, and the control unit 130 is externally connected to the network control chip 160 as shown in FIG. 2. For example, the control unit 130 can be a chip set on a motherboard.

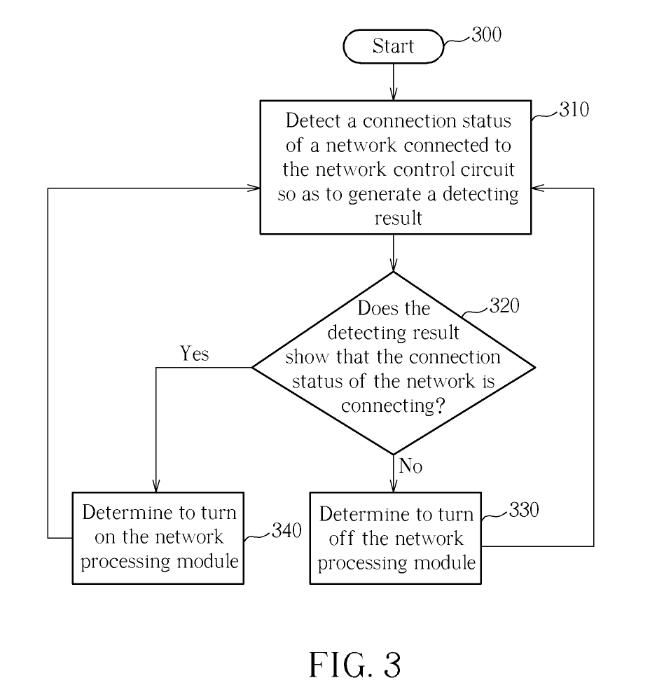

Please refer to FIG. 3. FIG. 3 is a flowchart showing a pseudo hot plug method applied to a network control circuit in accordance with the operation schemes of the network control circuit 100 in the above embodiments of the present invention, wherein the network control circuit comprises a network processing module for executing a network function of the network control circuit. Provided that substantially the same result is achieved, the steps of the process flowchart need not be in the exact order shown in FIG. 3 and need not be contiguous, that is, other steps can be intermediate. The pseudo hot plug method applied to the network control circuit according to the present invention comprises the following steps:

Step 300: Start.

Step 310: Detect a connection status of a network connected to the network control circuit so as to generate a detecting result.

Step 320: Determine whether to turn off the network processing module according to the detecting result, wherein when the detecting result shows that the connection status of the network is un-connecting, go to Step 330, and when the detecting result shows that the connection status of the network is connecting, go to Step 340.

Step 330: Determine to turn off the network processing module, and go back to Step 310.

Step 340: Determine to turn on the network processing module, and go back to Step 310.

Briefly summarized, the network control circuit disclosed by the present invention has a pseudo hot plug function so as to save power efficiently. Furthermore, the pseudo hot plug method disclosed by the present invention can be applied to various network control circuits.

Those skilled in the art will readily observe that numerous modifications and alterations of the device and method may be made while retaining the teachings of the invention.

What is claimed is:

1. A network control circuit having a pseudo hot plug function, comprising:
a network processing module, for executing a network function of the network control circuit;
a network detecting unit, for detecting a connection status of a network connected to the network control circuit so as to generate a detecting result; and
a control unit, coupled to the network detecting unit and the network processing module, for determining whether to turn off the network processing module according to the detecting result;
wherein when the detecting result shows that the connection status of the network is un-connecting, the control unit determines to turn off the network processing module, and when the detecting result shows that the connection status of the network is connecting, the control unit determines to turn on the network processing module.

2. The network control circuit of claim 1, wherein the network processing module is further coupled to a bus interface.

3. The network control circuit of claim 2, wherein the bus interface is a Peripheral Component Interconnect (PCI), a Peripheral Component Interconnect Extended (PCI-X), a Peripheral Component Interconnect Express (PCI-E), or an Universal Serial Bus.

4. The network control circuit of claim 1, wherein the network processing module, the network detecting unit, and the control unit are integrated in a same network control chip.

5. The network control circuit of claim 1, wherein the network processing module and the network detecting unit are integrated in a same network control chip, and the control unit is externally connected to the network control chip.

6. A pseudo hot plug method for a network control circuit, the network control circuit comprising a network processing module for executing a network function of the network control circuit, the pseudo hot plug method comprising:
detecting a connection status of a network connected to the network control circuit so as to generate a detecting result; and
determining whether to turn off the network processing module according to the detecting result.

7. The pseudo hot plug method of claim 6, wherein the step of determining whether to turn off the network processing module according to the detecting result further comprising:
when the detecting result shows that the connection status of the network is un-connecting, determining to turn off the network processing module; and
when the detecting result shows that the connection status of the network is connecting, determining to turn on the network processing module.
